(19) United States
(12) Patent Application Publication
(10) Pub. No.: US 2010/0282554 A1
(43) Pub. Date: Nov. 11, 2010

(54) Multi-chamber impact absorption system to protect individual

(76) Inventor: Thomas D. Stone, Scottsdale, AZ (US)

Correspondence Address: TOD R NISSLE, PO BOX 55630, PHOENIX, AZ, 85078, US

(21) Appl. No.: 12/658,344

(22) Filed: Feb. 5, 2010

Related U.S. Application Data
(60) Provisional application No. 61/215,897, filed on May 11, 2009.
(60) Provisional application No. 61/213,897, filed on Jul. 27, 2009.

(51) Int. Cl. F16F 9/02

(52) U.S. Cl. 188/322.13; 188/266

(57) ABSTRACT

A multi-chamber impact absorption system protects an individual by providing a bladder including a plurality of adjacent compressible fluid filled chambers.

This application claims priority based on provisional patent application Ser. No. 61/215,897, filed May 11, 2009.

Numerous foam padding and helmet liners and other systems have been used to dampen the force of a blow to an area on an individual's body. The general, commonplace motivation to improve such protection systems has existed for many years. This long existing commonplace motivation apparently has not, however, resulted in the development of any new liner systems that significantly improve protection, that have proven marketable, and that have had a significant impact in the market and in protecting individuals. The status quo remains.

Accordingly, it would be highly advantageous to provide a new liner system that effectively protects individuals, is marketable, and will have a significant impact in the marketplace and in protecting individuals from serious injury.

Therefore, it is a principal object of the invention to provide an improved impact absorption system for protecting participants in baseball, football, and various other activities in which protective equipment is worn.

This and other, further and more specific objects and advantages of the invention will be apparent from the following detailed description thereof, taken in conjunction with the drawings, in which:

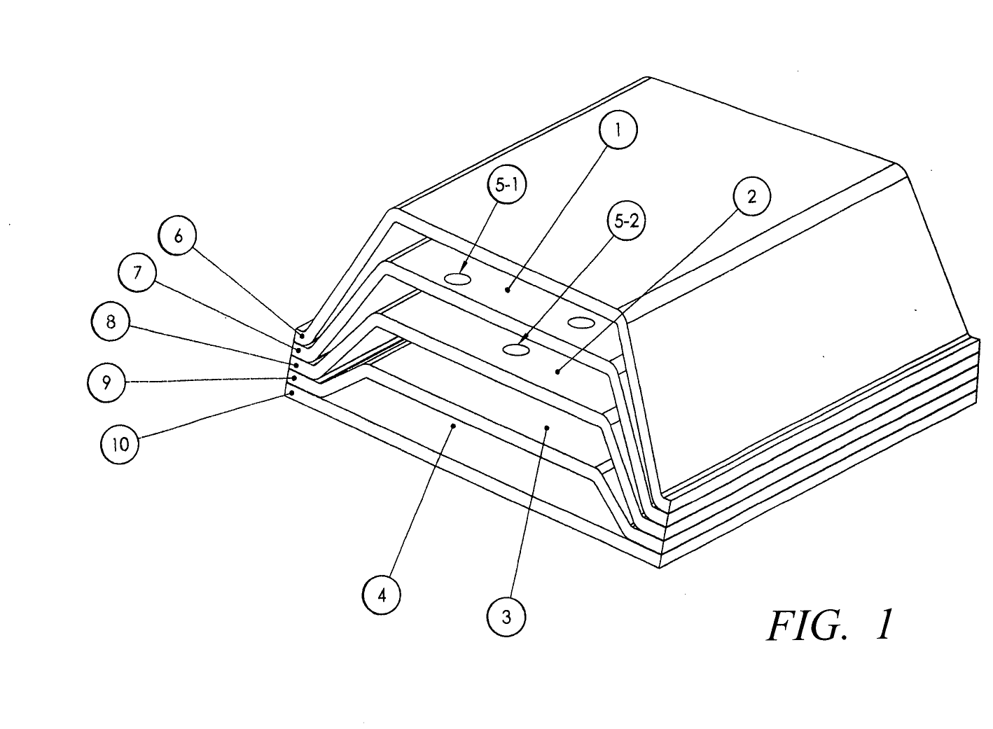

FIG. 1 is a perspective section view illustrating an impact absorption system constructed in accordance with the invention;

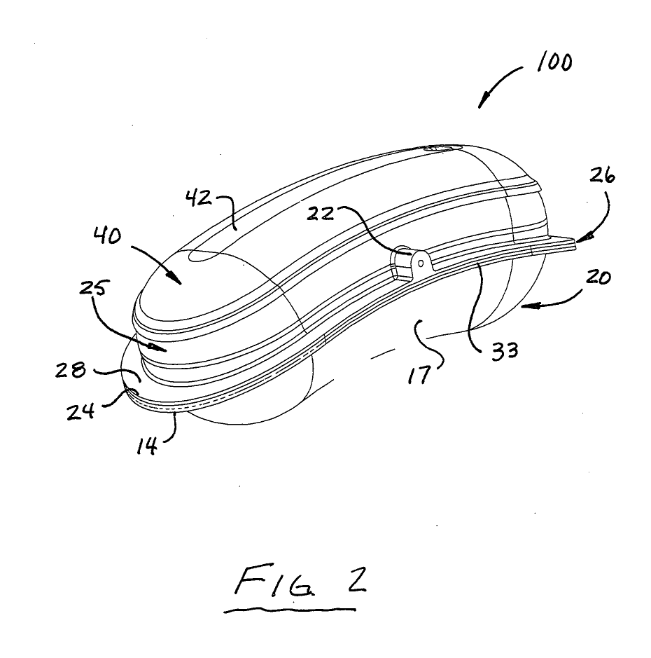

FIG. 2 is a perspective view illustrating an alternate embodiment of the impact absorption system of the invention;

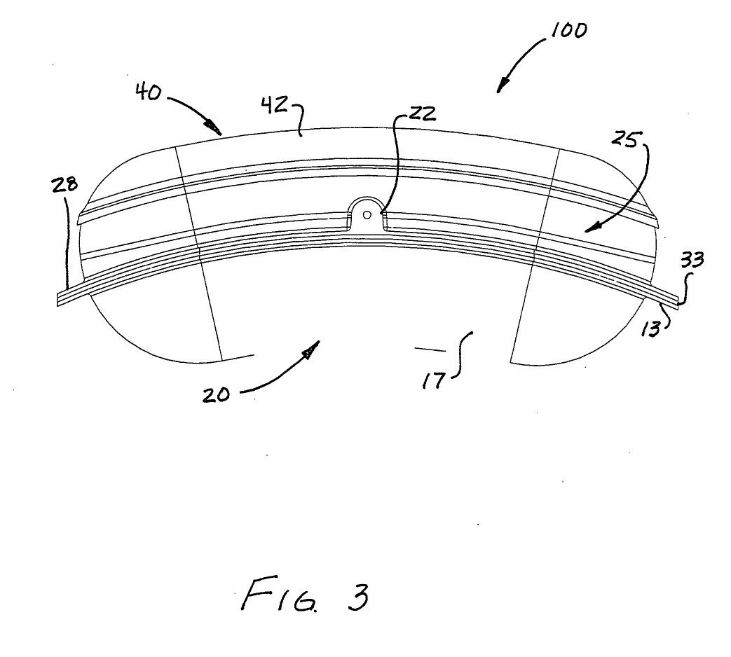

FIG. 3 is a front view of the impact absorption system of FIG. 2 illustrating additional construction details thereof;

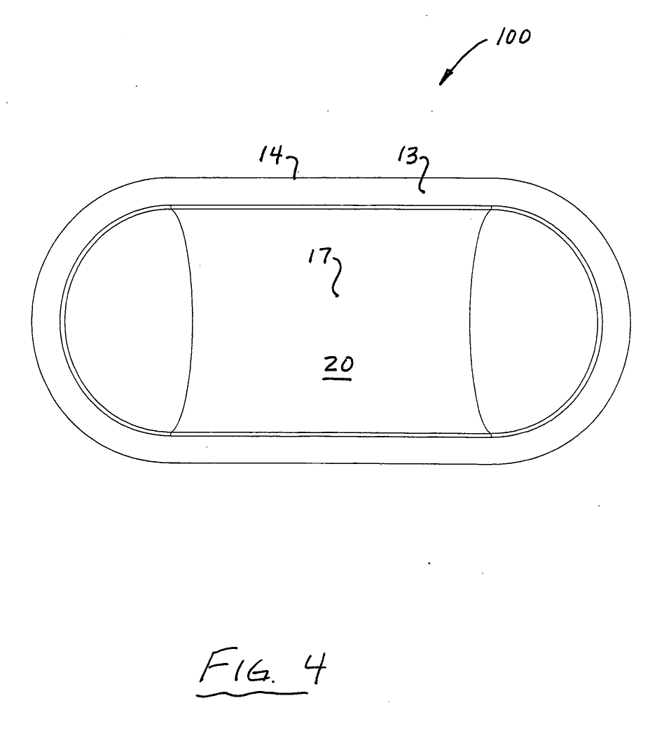

FIG. 4 is a bottom view illustrating the impact absorption system of FIG. 2;

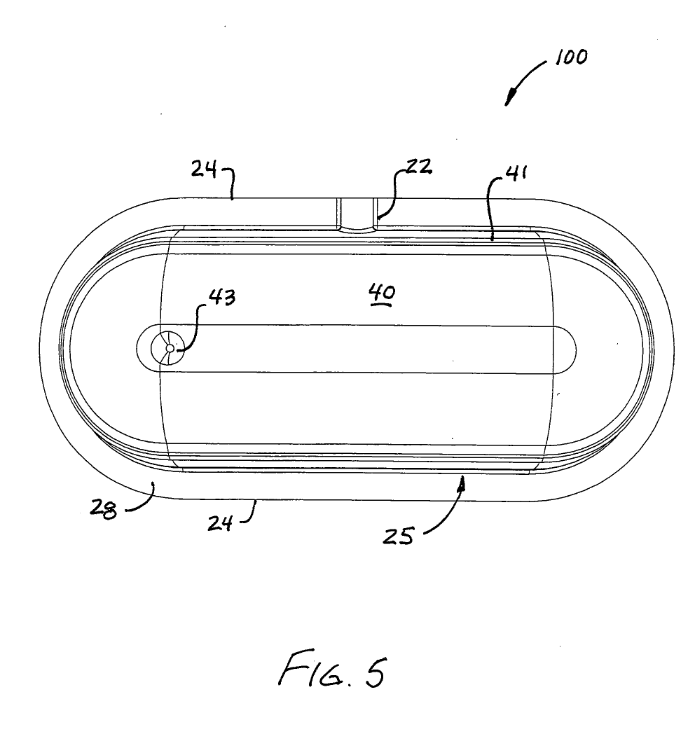

FIG. 5 is a top view illustrating the impact absorption system of FIG. 2;

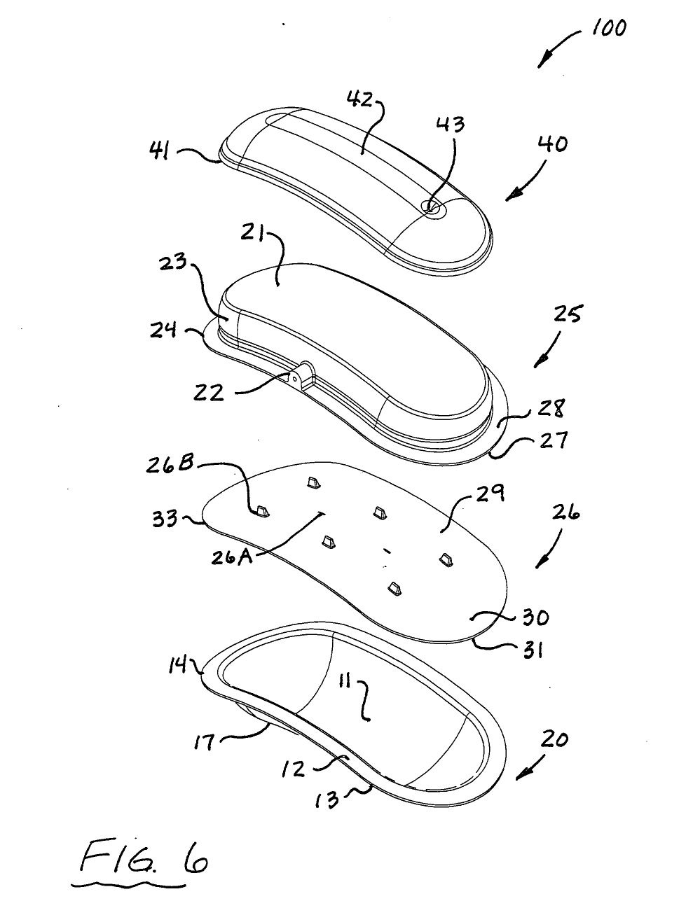

FIG. 6 is an exploded perspective view of the impact absorption system of FIG. 2 illustrating further construction details thereof;

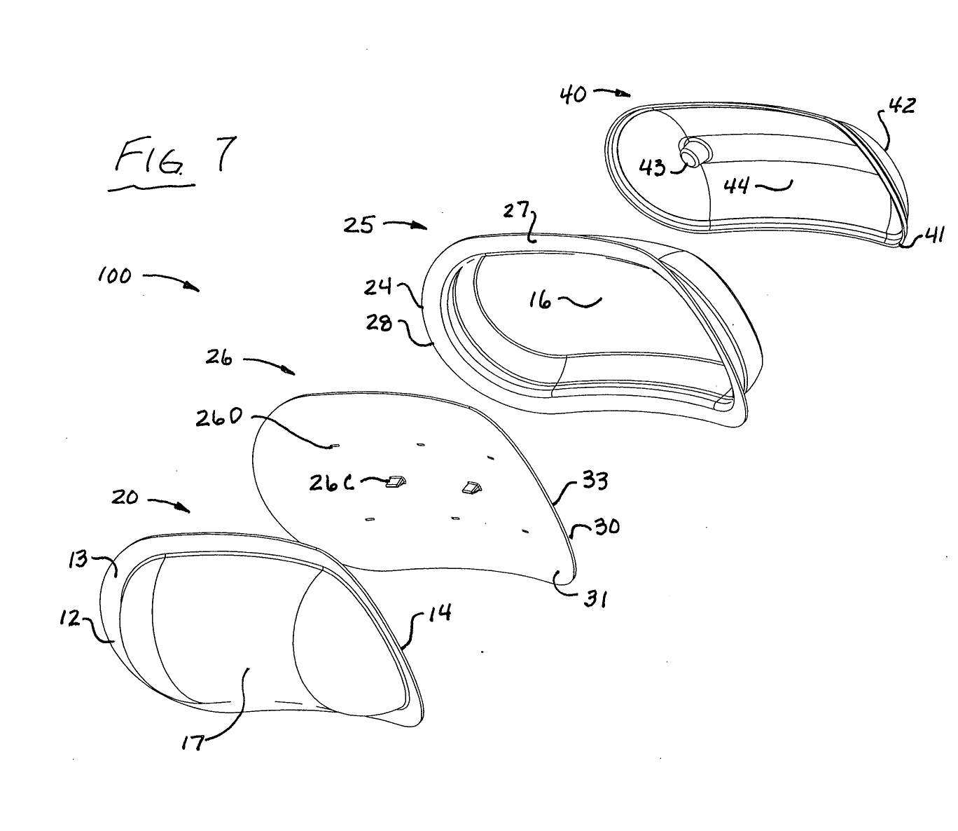

FIG. 7 is an exploded perspective view illustrating the impact absorption system of FIG. 2;

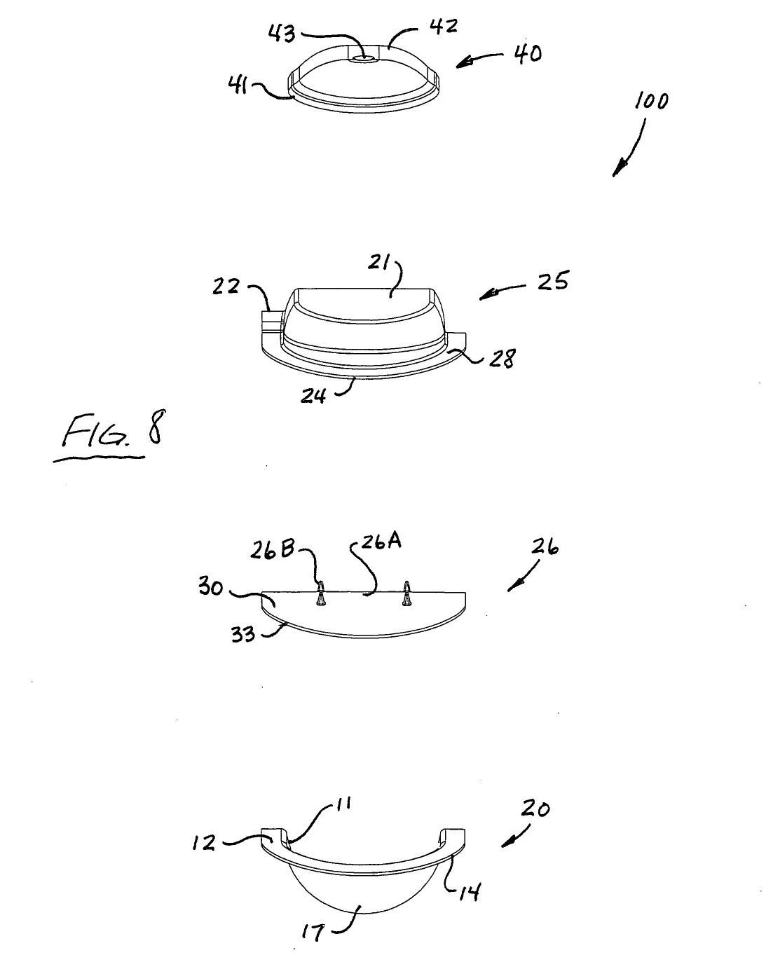

FIG. 8 is an exploded end view illustrating the impact absorption system of FIG. 2; and,

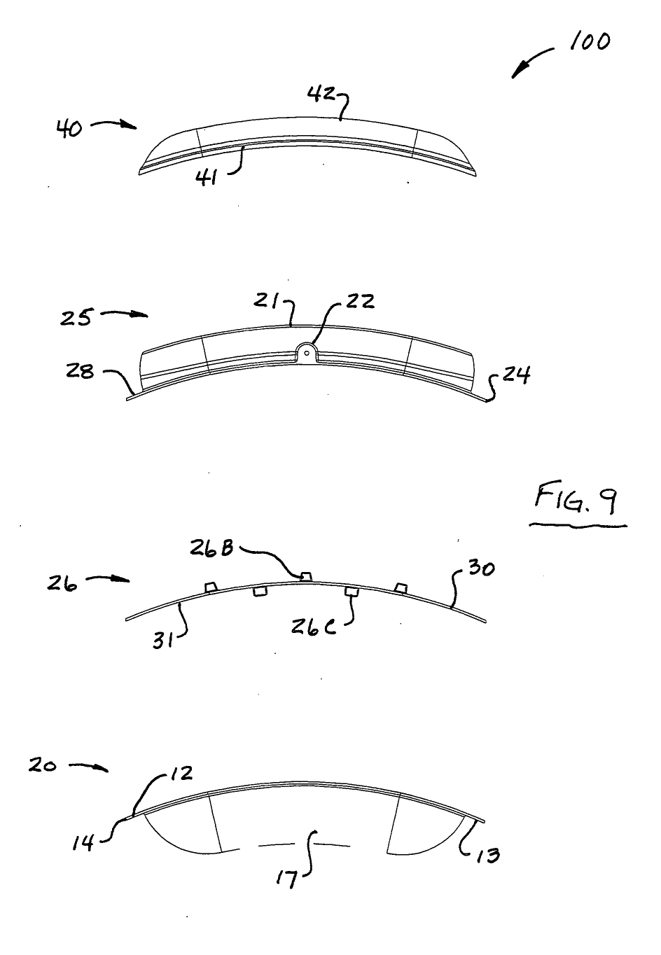

FIG. 9 is an exploded side view illustrating the impact absorption system of FIG. 2.

Briefly, in accordance with the invention, I provide a sealed, resilient, impact dampening apparatus including a plurality of internal gas-filled chambers separated by at least one internal perforated resilient wall to permit the travel of gas therebetween such that the impact resistance produced by one of the chambers differs from the impact resistance produced by another one of the chambers. A valve can be mounted on at least the perforation.

Turning now to the drawings which are presented by way of example and not limitation, and in which like reference characters refer to corresponding elements throughout the several views, FIG. 1 illustrates an impact absorption system constructed in accordance with the principles of the invention.

The system of FIG. 1 includes resilient elastic layers 6 to 10. Layers 6 and 7 bound and enclose chamber or space 1. Layers 7 and 8 bound and enclose chamber 2. Layers 8 and 9 bound and enclose chamber 3. Layers 9 and 10 bound and enclose chamber 4. FIG. 1 is a cut away view. Although not fully shown in FIG. 1, the peripheral edges of layers 6 to 10 are sealed together and completely circumscribe and enclose chambers 1 to 4. Perforations 5-1 extend through layer 7. Perforations 5-2 extend through layer 8. Perforations 5-1 permit air or another gas (or liquid) to pass through perforations 5-1 and move between chambers 1 and 2. Perforations 5-2 permit air or another gas (or liquid) to pass through perforations 5-2 and move between chambers 3 and 4. Perforations 5-1 are equivalent to perforations 5-2 in shape and dimension, although this need not be the case. Perforations 5-1 and 5-2 can be cylindrical with a circular cross-sectional area, can have a hexagonal cross sectional area, can have a triangular cross section area, etc. In an alternate embodiment of the invention, the size of perforations 5-1 differs from that of perforations 5-2. In a further embodiment of the invention the size of perforations 5-1 varies, i.e., one perforation 5-1 is larger than another perforation 5-1 in layer 7. In another embodiment of the invention the size of perforations 5-2 varies.

The number of perforations 5-1 presently formed in layer 7 is greater than the number of perforations 5-2 formed in layer 8 so that air more readily moves from chamber 1 into chamber 2 than does air moving from chamber 2 to chamber 3. However, perforations 5-1 can be sized such that even though the number of perforations 5-1 is less than or equal to the number of perforation 5-2, air still flows from chamber 1 to chamber 2 more quickly than air flows from chamber 2 to chamber 3, i.e., at least some perforations 5-1 can be larger than at least some of perforations 5-2.

Perforations are not formed through layer 9. Consequently, air cannot move from chamber 3 to chamber 4, or vice versa.

One objective of the structure illustrated in FIG. 1 is to make the resistance to compression produced by at least some of chambers 1 to 4 progressively greater.

Assuming for sake of discussion that the volume of each chamber is substantially equivalent (although this need not be the case), when compressive forces are applied to the system or structure of FIG. 1 that tend to compress layer 6 toward layer 10, movement of air from chamber 1 to chamber 2 occurs more readily and quickly than does movement of air from chamber 2 to chamber 3. Accordingly, the air in chamber 2 provides more resistance to compression than does the air in chamber 1. Similarly, the air in chamber 3 provides more resistance to compression than does the air in chamber 2. The air in chamber 4 normally provides more resistance to compression than the air in chambers 1 and 2, ostensibly because the air in chamber 1 and 2 can escape into chamber 3. Since, however, air cannot readily escape from chamber 3 and a significant portion of the air from chambers 1 and 2 flows into chamber 3, chamber 3 can possibly provide greater resistance to compression than chamber 4.

In the embodiment of the invention illustrated in FIG. 1, layer 6 would be closest to and adjacent or contacting the head or other desired area of the body of a user. Layer 10 would be connected to a helmet, a piece of clothing, or other desired carrier or support structure. A compressible filler material can be placed in chambers 1, 2, 3, and/or 4.

In an alternate embodiment of the invention, valves are utilized in place of and instead of perforations 5-1 and/or 5-2. For example, in layer 7 perforations 5-1 are not utilized and one or more transfer valves are installed in layer 7. The transfer valves permit air to flow from chamber 1 into chamber 2 and do not permit air to flow from chamber 2 into chamber 1. In addition, return valves are installed in layer 7 and are separate from the transfer valves. The return valves permit air to flow from chamber 2 into chamber 1 and do not permit air to flow from chamber 1 into chamber 2.

In another embodiment of the invention the valves installed in layer 7 (and if desired in layer 8) are two way valves and permit air to flow from chamber 1 into chamber 2 when the pressure in chamber 1 is greater than in chamber 2; and, permit air to flow from chamber 2 into chamber 1 when the pressure in chamber 2 is greater than the pressure in chamber 1. The construction and functioning of the valves can vary as desired.

In still another embodiment of the invention, perforations are formed in a layer 7 and/or 8 and valves are also utilized in a layer 7 and/or 8

Another embodiment of the invention is illustrated in FIGS. 2 to 10 and is intended to be placed inside a helmet or to be utilized as padding on the interior of football shoulder pads or knee pads, or, to be utilized as protective padding in other sports or endeavors.

The impact absorption system of FIG. 2 is generally indicated by reference character 100 and includes four components which are sealed together about their peripheral edges to form three separate gas-filled sealed chambers. As will be seen, a first gas (or other fluid) filled chamber exists between component 40 and component 25. A second gas filled chamber exists between components 25 and 26. And, a third gas filled chamber exists between components 26 and 20. These components are more readily observed in the exploded views of FIGS. 6 to 9.

FIGS. 2 to 5 illustrate the system of FIG. 2 in its assembled configuration.

Component 40 comprises the top member of system 100 and, in a batting helmet or football helmet, is positioned adjacent—and typically attached to—the inside of the helmet while component 20 comprises the bottom member of system 100 and is adjacent, contacts, and conforms to the head of the individual that is wearing the batting helmet or football helmet. Components 25 and 26 are located intermediate components 20 and 40.

Components 20, 25, 26, 40 are sealed together as follows to produce the three sealed gas-filled chambers noted above. Surface 12 of the peripheral edge 14 of component 20 is sealingly secured along its entire length with adhesive, heat sealing, or another sealing process to the bottom surface 31 of the peripheral edge 33 of member 26. Surface 27 of component 25 is sealingly secured along its entire length with adhesive or another sealing process to the upper surface 30 of the peripheral edge 33 of component 26 Edge 41 of component 40 is sealingly secured along its entire length with adhesive or another sealing process to the upper portion of side 23 (FIG. 6) of component 25.

As can more readily be seen in FIGS. 6 to 9, component 40 includes lower peripheral edge 41, crown 42, and valve 43 for injecting gas or another fluid into the chamber that is formed and extends between crown 42 and upper surface 21 on the top of component 25.

Component 25 include peripheral edge 24 with upper surface 28 and lower surface 27. Valve 22 is utilized to inject gas or another fluid into the chamber that is formed and extends between upper surface 29 of component 26 and the top of component 25.

Slotted openings 26D (FIG. 7) are formed through the bottom surface 31 of component 26 and, if desired, each extend into a one-way valve that permits gas to flow from the chamber intermediate components 20 and 26 into the chamber intermediate components 25 ad 26. Slotted openings 26A (FIG. 6) are formed through the upper surface 29 of component 26 and, if desired, each extend into a one-way valve 26C that permits gas to flow from the chamber intermediate components 25 and 26 into the chamber intermediate components 20 and 26. The shape and dimension of openings 26A and 26D can vary as desired, and such openings need not include or be associated with valves.

When system 100 is in an “at-rest” configuration and is not being compressed, openings 26D and 26A permit the pressure in the chamber intermediate components 20 and 26 to generally equalize with the pressure in the adjacent chamber that is intermediate components 25 an 26.

When, however, system 100 is subjected to compressive forces, as for example when a thrown baseball hits a helmet that is being worn by a batter and has system 100 mounted inside the helmet, slotted openings 26D and valves 26B permit air to flow from the chamber intermediate components 20 and 26 to the chamber intermediate components 26 and 25 more rapidly than slotted openings 26A and valves 26C permit air to flow from the chamber intermediate components 26 and 26 to the chamber intermediate components 20 and 26. This slot-valve system permits the chamber intermediate components 20 and 26 to more rapidly contract and absorb compressive forces than the chamber intermediate components 25 and 26 can contract and absorb compressive forces.

As can be seen in FIG. 7, component 40 includes inner surface 44, component 25 includes inner surface 16, and component 20 includes arcuate outer surface 17.

Elastic resilient components 20, 25, 26, 40 can be constructed from any desired material but presently preferably are constructed from TPE, TPR, SANTOPRENE™ or another polymer with a durometer in the range of 20 to 70, preferably 30 to 60, and more preferably 40 to 50. Neoprene is presently not acceptable because it is too porous.

During the construction of system 100, the “at-rest” pressure in each chamber is presently about equivalent to atmospheric pressure at sea level. A lower or greater pressure can, if desired, be utilized.

In one presently preferred embodiment, system 100 is about four and one half inches long, two and one-half inches wide, and two inches thick (high). In another embodiment of the invention, system 100 is five and three-eighths inches long, one and seven eighths inches wide, and one and five-eighths inches thick. The shape and dimension of system 100 can be varied as desired, and system 100 can be constructed to include two or more fluid-containing chambers.

When system 100 is utilized in a helmet or on other protective equipment, more than one system can be utilized. For example, one system 100 can be attached inside a helmet to the top of the helmet, a second system 100 can be attached inside a helmet to one side of the helmet, a third system 100 can be attached inside a helmet to the other side of the helmet, and a fourth system 100 can be attached inside a helmet to the back of the helmet.

In one preferred embodiment of the invention, a baseball helmet, football helmet, or other protective equipment is, along with the system(s) 100 that are installed in the helmet, sized so that when a player wears the helmet, the system 100 is preloaded. When a system 100 is preloaded it is partially compressed by an individual's head when the helmet is worn. A typical, presently preferred preloading occurs when a system 100 is compress about one-quarter of an inch from the “at-rest” configuration that system 100 achieves if it is simply resting on a table or other support surface without any compressive forces applied to system 100 other than forces generated by gravity.

One proposed helmet design includes eleven systems 100 mounted inside the helmet.

In another embodiment of the invention, the helmet worn by a player extends down over the back of the neck and/or over the termporal area of the player's head.

The thickness of the material in components 20, 25, 26, 40 can vary. The currently preferred thickness is in the range of one thirty-second of an inch to one eighth of an inch. The material is preferably thick enough to permit system 100 to absorb repeatedly significant G forces in the range of one to 400 G′s, preferably at least up to 60 G′s. A 60 G force normally is sufficient to cause a concussion.

The number of chambers 1 to 4 can vary as desired. Further, in some cases it may be preferred to have a number of chambers at one location inside a helmet or other protective gear that varies from the number of chambers at another location insider the helmet. The chambers can be filled with any desired fluid including any desired gas or mixture of gases or any desired liquid or mixture of liquids. Nitrogen is presently one preferred gas. The durometer of material utilized in the construction of the absorption system of the invention can vary as desired.

Having described my invention and the presently preferred embodiments thereof in a manner sufficient for one of ordinary skill in the art to understand and practice,

I claim:

1. A sealed, resilient, sealed impact dampening apparatus including a plurality of internal gas-filled chambers separated by at least one internal perforated resilient wall to permit the travel of gas therebetween such that the impact resistance produced by one of said chamber's differs from the impact resistance produced by another one of said chambers.

2. The apparatus of claim 1 wherein a valve is mounted on at least said perforation.
